(19) United States
(12) Patent Application Publication
(10) Pub. No.: US 2016/0182430 A1
(43) Pub. Date: Jun. 23, 2016

(54) OPTIMIZING VIEW OF MESSAGES BASED ON IMPORTANCE CLASSIFICATION

(71) Applicant: Microsoft Technology Licensing, LLC, Redmond, WA (US)

(72) Inventors: Vignesh Sachidanandam, Seattle, WA (US); Hiroshi Tsukahara, Bellevue, WA (US); Ned Bearer Friend, Seattle, WA (US)

(21) Appl. No.: 14/572,811

(22) Filed: Dec. 17, 2014

(51) Int. Cl. H04L 12/58; G06F 3/0484; G06F 3/0482

(52) U.S. Cl. CPC H04L 51/26; H04L 51/22; H04L 51/12; G06F 3/0482; G06F 3/04842; H04L 51/24

(57) ABSTRACT

Optimization of a view of messages based on an importance classification is provided. An application such as a communication application displays summaries of messages within a summary pane of a messaging user interface (UI). The messages include emails. An action is detected that activates an importance filter control, where the importance filter control includes operations to identify an important subset of the summaries associated with the messages classified as an important message. The messages are processed to identify the important subset. The important subset are displayed while hiding a remaining subset of the summaries on the summary pane.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications display messages through a display and enable users to provide input associated with the applications' operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to optimization of a view of messages based on an importance classification. In some example embodiments, a messaging application may display summaries of the messages within a summary pane of a messaging user interface (UI). An action may be detected that activates an importance filter control, where the importance filter control includes operations to identify a subset of the summaries corresponding to the messages classified as important. The messages may be processed to identify the subset of the summaries corresponding to the messages classified as important. The subset of the summaries corresponding to the messages classified as important may be displayed while a remaining subset of the summaries may be hidden on the summary pane.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of optimizing a view of messages based on an importance classification, according to embodiments;

FIG. 2 illustrates an example of displaying summaries of messages on a summary pane of a messaging user interface (UI), according to embodiments;

FIG. 3 illustrates an example of optimizing the summary pane based on an importance classification, according to embodiments;

FIG. 4 illustrates an example of placing summaries of incoming messages along with summaries of messages classified as an important message, according to embodiments;

FIG. 5 illustrates an example of expansion of information on summaries of messages classified as an important message or an unread message, according to embodiments;

FIG. 6 is a simplified networked environment, where a system according to embodiments may be implemented;

FIG. 7 illustrates a general purpose computing device, which may be configured to optimize a view of messages based on an importance classification; and

FIG. 8 illustrates a logic flow diagram for a process to optimize a view of messages based on an importance classification, according to embodiments.

### DETAILED DESCRIPTION

As briefly described above, a view of messages may be optimized based on an importance classification by a messaging application. Summaries of the messages may be displayed within a summary pane of a messaging user interface (UI). The messages may include emails. An action may be detected that activates an importance filter control, where the importance filter control includes operations to identify an important subset of the summaries associated with the messages classified as an important message. The messages may be processed to identify the important subset. The important subset may be displayed while a remaining subset of the summaries may be hidden on the summary pane.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to optimize a view of messages based on an importance classification. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

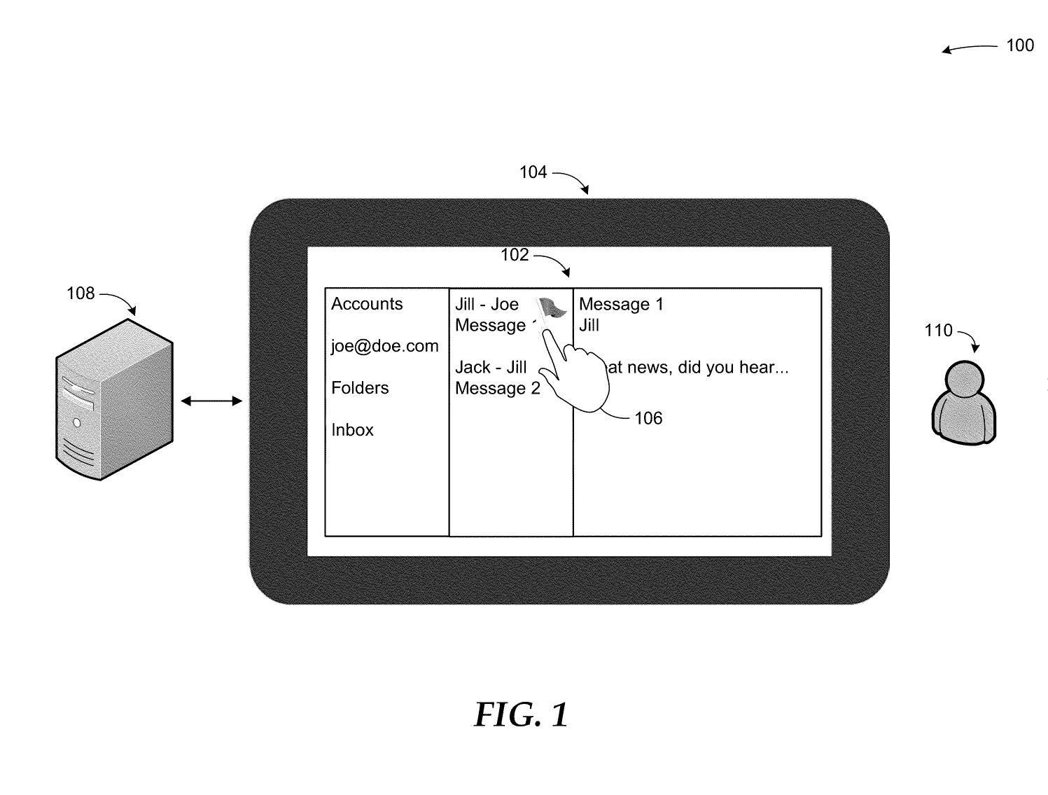

FIG. 1 is a conceptual diagram illustrating an example of optimizing a view of messages based on an importance classification, according to embodiments.

In a diagram 100, a computing device 104 may execute a messaging application 102. The computing device 104 may include a tablet device, a laptop computer, a desktop computer, and a smart phone, among others. The computing device 104 may display the messaging application 102 to a user 110. The user 110 may be allowed to interact with the messaging application 102 through an input device or touch enabled display component of the computing device 104. The computing device 104 may include a display device such as the touch enabled display component, and a monitor, among others to provide a user interface of the messaging application 102 to the user 110.

The messaging application 102 may classify a message as an important message based on an action 106 that activates an importance flag control. The importance flag control may include operations to classify the message as an important message. The message may also be classified as an important message in response to a detection that the message may include an unfinished draft, a message sent to self, or an unread message from a supervisor, among others. The operations may be executed in response to an interaction of the user 110 activating the importance flag control. The user 110 may interact with the messaging application 102 with a keyboard based input, a mouse based input, a voice based input, a pen based input, and a gesture based input, among others. The gesture based input may include one or more touch based actions such as a touch action, a swipe action, and a combination of each, among others.

The messaging application 102 may retrieve messages from a local source such as a storage media, a memory, a hard disk drive, and a solid state drive, among others. The messages may also be received from a remote source such as a server 108 that provides messaging services. The messaging services may relay messages transmitted from other sources sent to an account associated with the user 110. The messaging application 102 may receive the messages, optimize the messages based on an importance classification, and display the messages to the user through the computing device 104.

While the example system in FIG. 1 has been described with specific components including the computing device 104, the messaging application 102, embodiments are not limited to these components or system configurations and can be implemented with other system configuration employing fewer or additional components.

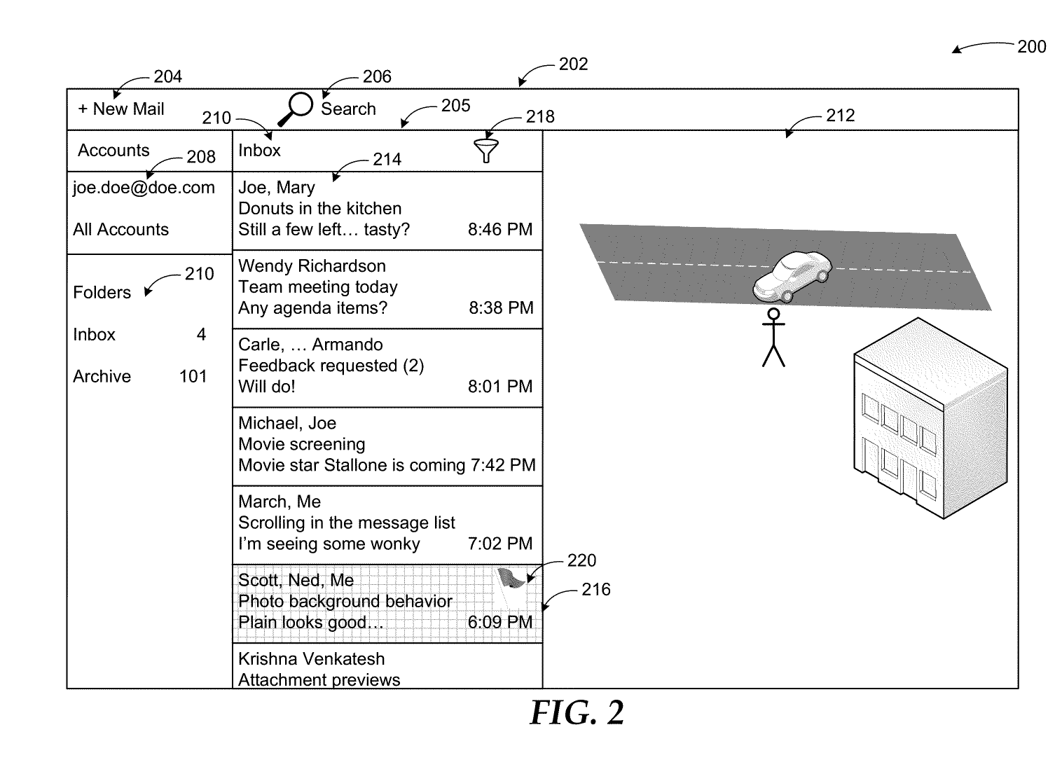

FIG. 2 illustrates an example of displaying summaries of messages on a summary pane of a messaging user interface (UI), according to embodiments.

In a diagram 200, a messaging application 202 may display a view of messages based on an importance classification. The messaging application 202 may provide a summary pane 205 to display summaries of messages and a content pane 212 to display a content of a message.

The messaging application 202 may provide controls to manage messages, conversations, or communications, among others. The messages may include an email, a text based message, an audio message, or a video message, among others. A new message control 204 may include operations to provide a UI to create a new message. A search control 206 may include operations to search the messages based on a search parameter to locate a message that matches the search parameter. The messaging application 202 may also provide controls to manage accounts associated with messages. An account control 208 may be used to select messages associated with an account. Folder controls 210 may be selected to display summaries of messages in folders associated with the account. The folders may include an inbox, a sent folder, an outbox, and an archive, among others.

A summary pane 205 of the UI of the messaging application 202 may display summaries of messages stored in a folder 211, such as an inbox. The summary pane 205 may also provide an importance filter control 218. The importance filter control 218 may include operations to identify messages classified as an important message and display summaries of the messages classified as an important message on the summary pane 205.

A summary 214 of a message may display a sender identification, a receiver identification, a message subject that displays a visual indicator of a new message or an unread message, one or more lines summary of a message content, or a timestamp, among other attributes of an associated message. The timestamp may be a time of when the message was sent. Alternatively, the timestamp may be a time of when the message was received. The summary 214 may also display the associated message classified as a trivial message. The summary 214 may lack an indicator that classifies the associated message as an important message. The indicator may be a flag, a pin, a colored timestamp, or a background highlight color, among others.

A summary 216 of a message classified as an important message may display a an importance flag control 220. The importance flag control 220 may be used to classify the message associated with the summary as an important message. An activated flag control such as the importance flag control 220 may indicate that the associated message is classified as an important message. The message may also be classified as an important message in response to a detection that the message may include an unfinished draft, a message sent to self, or an unread message from a supervisor, among others.

The summary 216 may also be displayed with a highlighting, a coloring, or a shading, among other schemes to differentiate the summary 216 from the other summaries displayed on the summary pane 205. The summary 216 may be differentiated from the other summaries in response to an action selecting the summary 216. The selection may activate operations to display a content of the message associated with the summary 216 on a content pane 212. The content pane 212 may be displayed adjacent to the summary pane 205. The location of the content pane 212 may be user or application configurable. In an example scenario, the content pane 212 may be displayed below the summary pane 205.

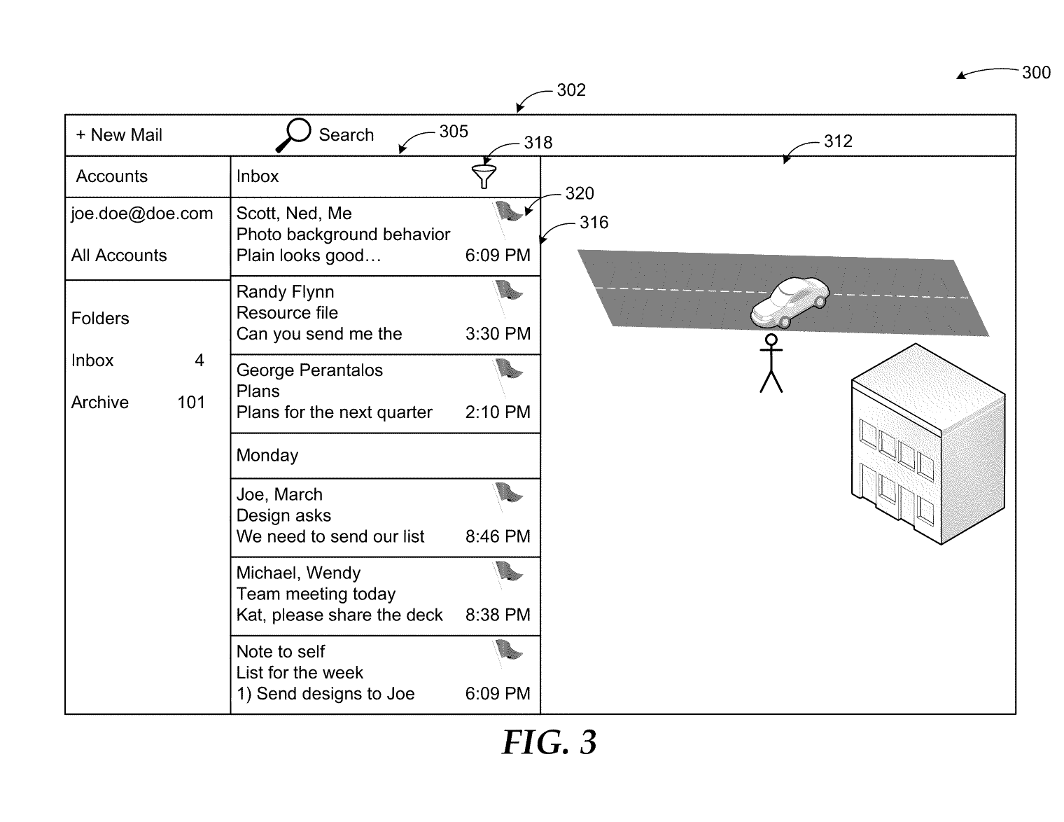

FIG. 3 illustrates an example of optimizing the summary pane based on an importance classification, according to embodiments.

In a diagram 300, a messaging application 302 may optimize a view of messages on a UI of the message application 302. The messaging application 302 may identify messages classified as an important message, in response to detecting an activation of the importance filter control 318. An important subset of the summaries of the messages, classified as an important message, may be displayed on the summary pane 305. Each summary in the important subset may display an importance flag control 320 as activated to indicate that an associated message is classified as an important message. A message may be classified as an important message by a user such as an owner of an account associated with the messages. Alternatively, a message may be classified as an important message automatically in response to an analysis of attributes of the message. A message identified as an unfinished message, a message from a supervisor, a message sent to self, a message marked for a follow up action that has not been completed, or a message marked for a follow up that has not been responded, among others may be classified an important message.

The important subset of the summaries displayed on the summary pane 305 may be sorted based on a chronological order, a sender name, or a message subject, among others that places a recent summary on top of the summary pane 305. The content of the message associated with the recent summary such as the summary 316 may be displayed on a content pane 312 by default. A user action selecting another one of the important subset of the summaries displayed on the summary pane 305 may initiate operations to display the content of the message associated with selected summary on the content pane 312.

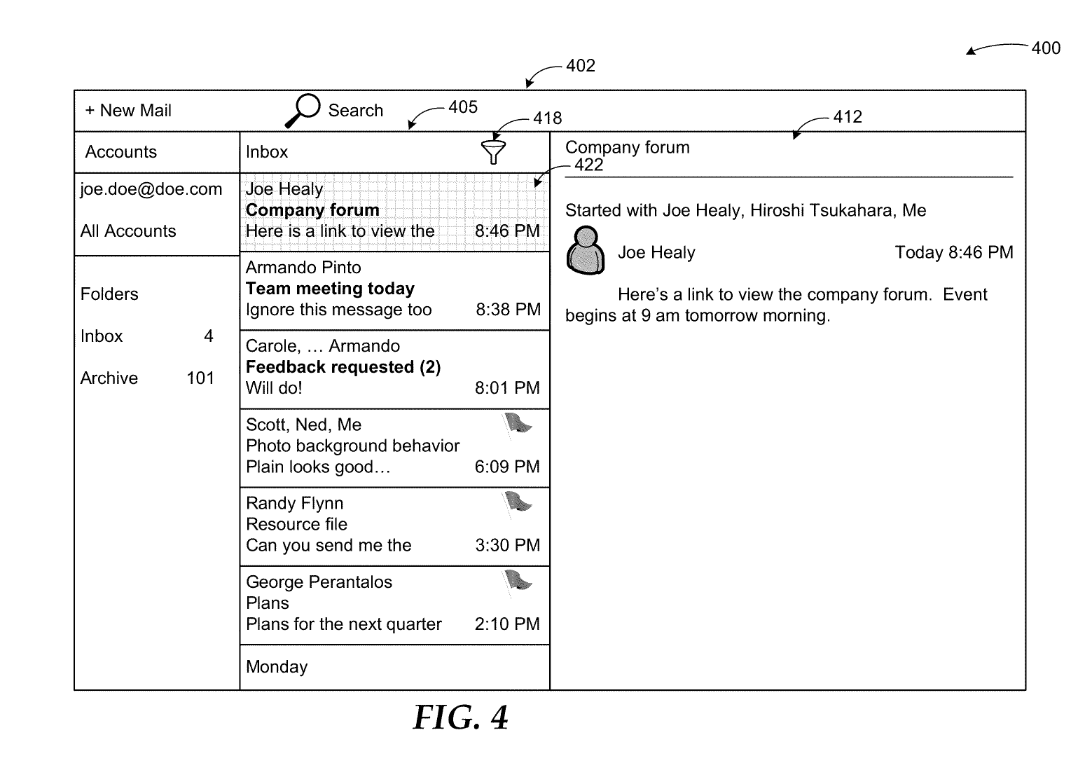

FIG. 4 illustrates an example of placing summaries of incoming messages along with summaries of messages classified as an important message, according to embodiments.

In a diagram 400, a messaging application 402 may display a view of messages optimized based on an importance classification. The messaging application 402 may continue to display summaries of incoming messages above important subset of summaries of messages classified as an important message. A new summary 422 may display an importance flag control that is deactivated to indicate that an associated message is classified as a trivial message. The new summary 422 may also provide an indicator such as a message subject displayed in bold lettering to indicate that the message is an unread message. In response to an action selecting the new summary 422, a content of an associated message, such as the incoming message, may be displayed on the content pane 412. A highlighting or another scheme may be used to indicate the new summary 422 as selected, in response to a user action selecting the new summary 422.

The importance filter control 418 may be deactivated to display summaries of a remaining subset of the summaries that were hidden while the importance filter control 418 was activated. An unread subset of the summaries may be continued to be displayed above the subset of the summaries corresponding to the messages classified as important. The remaining subset may be associated with the messages classified as a trivial message. A user may be allowed to interact with the summaries to classify the messages associated with the summaries as an important message or a trivial message.

A message may be re-classified as an important message in response to an activation of the importance flag control displayed on an associated summary. The message may also be re-classified as an important message or a trivial message based on other signals. An example signal may include automatically re-classifying an important message into a trivial message in response to a completion of a draft message and a transmittal the completed message. The message may also be re-classified as a trivial message in response to a deactivation of the importance flag control displayed on an associated summary. A re-classified summary may be removed from the important subset in response to the reclassification of the associated message as the trivial message. A re-classified summary may be added to the important subset in response to the reclassification of the associated message as an important message. In response to detecting an action activating the importance filter control 418 the important subset of the summaries may be displayed on the summary pane 405.

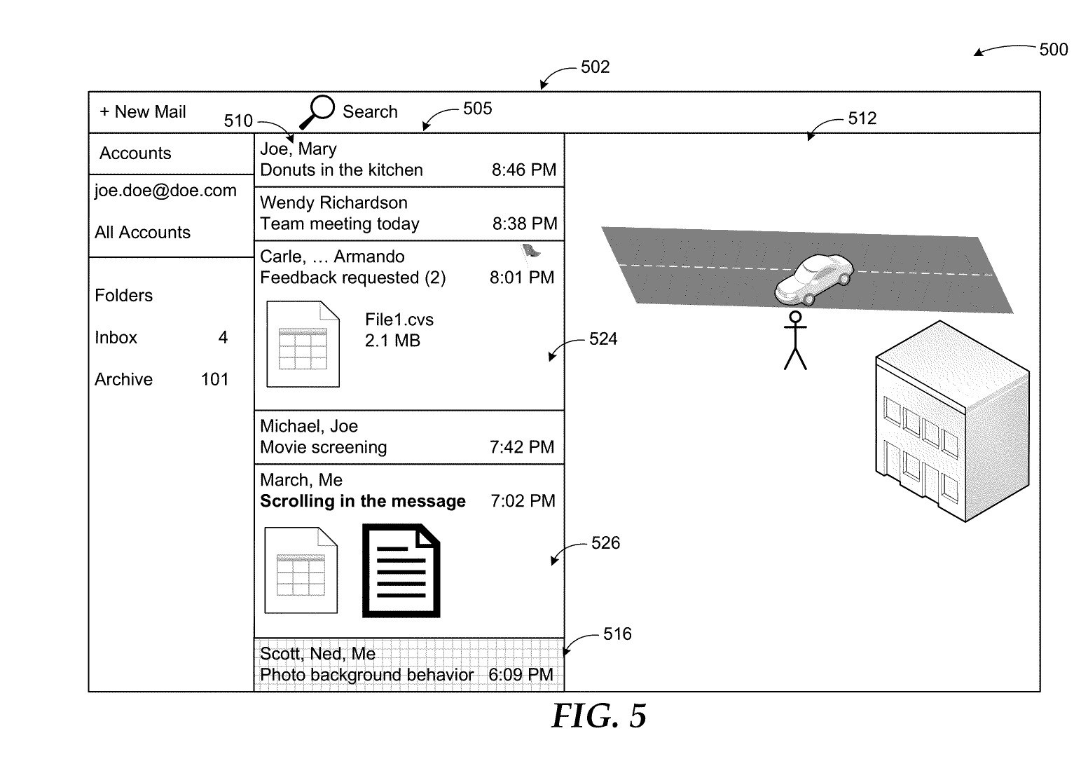

FIG. 5 illustrates an example of expansion of information on summaries of messages classified as an important message or an unread message, according to embodiments.

In a diagram 500, a messaging application 502 may optimize a view of messages based on an importance classification. The messaging application 502 may display a summary pane 505 that provides reduced summaries of messages that are classified as a read message and a trivial message. An example summary such as the summary 510 may be associated with a message classified as a read message and trivial message. The reduced summary may include a sender identification, a receiver identification, a message subject that displays a visual indicator of a new message or an unread message, or a timestamp, among other attributes to be displayed on the summary pane 505.

A summary such as the expanded summary 524 may be associated with a message classified as an important message. An importance flag control on the expanded summary 524 may be displayed as activated to indicate that the associated message may be classified as an important message. The expanded summary 524 may display a sender identification, a receiver identification, a message subject that displays a visual indicator of a new message or an unread message, one or more lines summary of a message content, and a timestamp, an icon and a size information for each attached document of an associated message, or a thumbnail view for each attached image, video, or document, among other attributes of the associated message on the summary pane 505. An icon of the image, the video, or the document, among others may be displayed in response to an inability to locate a thumbnail view for the attached content.

A summary such as an expanded summary 526 may be associated with a message classified as an unread message. The importance control on the expanded summary 526 may be deactivated to indicate that the message is classified as a trivial message. However, because of the unread message classification the expanded summary 526 may display additional information about the associated message. The expanded summary 526 may display a sender identification, a receiver identification, a message subject that displays a visual indicator of a new message or an unread message, one or more lines summary of a message content, and a timestamp, an icon and a size information for each attached document of an associated message, or a thumbnail view for each attached image, video, or document, among other attributes of the associated message on the summary pane 505. An icon of the image, the video, or the document, among others may be displayed in response to an inability to locate a thumbnail view for the attached content

A user may also select a reduced summary 516. A selected status of the reduced summary 516 may be indicated through an illustration scheme such as a highlighting of the reduced summary 516, among other schemes. A content of a message associated with the reduced summary 516 may be displayed on a content pane 512 in response to detecting a selection of the reduced summary 516.

In addition, the messages classified as an important message may be analyzed through a machine learning algorithm. The messages classified as an important message may be analyzed to classify incoming messages automatically as an important message or a trivial message.

The technical advantage of optimizing a view of messages based on an importance classification may include improved usability of user interfaces that present messages while distinguishing important messages from trivial messages compared to legacy messaging solutions.

The example scenarios and schemas in FIG. 1 through 5 are shown with specific components, data types, and configurations. Embodiments are not limited to systems according to these example configurations. Optimizing a view of messages based on an importance classification may be implemented in configurations employing fewer or additional components in applications and user interfaces. Furthermore, the example schema and components shown in FIG. 1 through 5 and their subcomponents may be implemented in a similar manner with other values using the principles described herein.

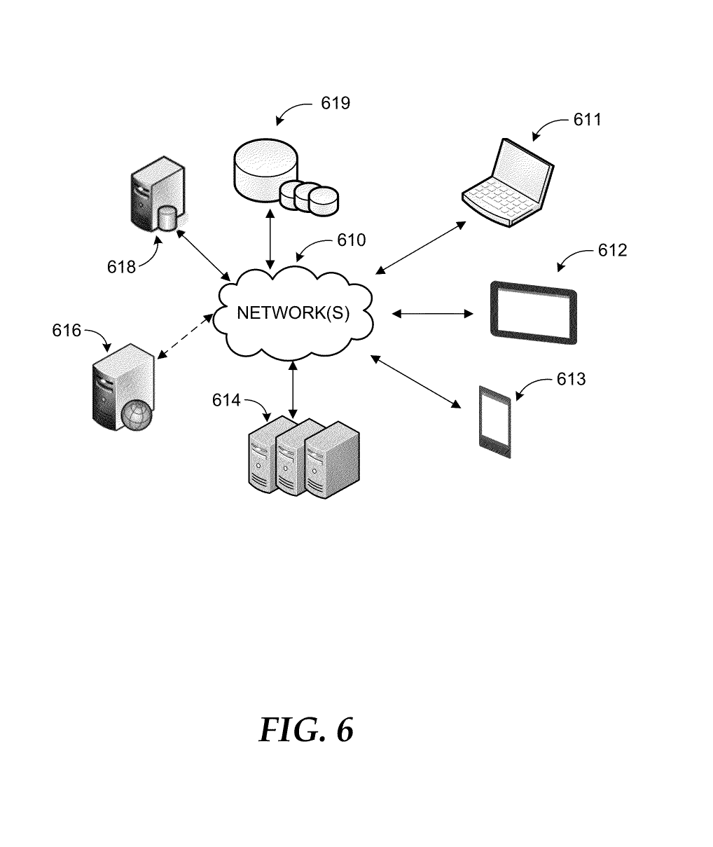

FIG. 6 is an example networked environment, where embodiments may be implemented. A messaging application configured to optimize a view of messages based on an importance classification may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A messaging application may detect an action activating an importance filter control to filter summaries of messages based on a classification as an important message. The messages may be processed to identify the important subset of the summaries. The important subset may be displayed while hiding a remaining subset of the summaries on the summary pane. The messaging application may store data associated with the messages in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to optimize a view of messages based on an importance classification. Furthermore, the networked environments discussed in FIG. 6 are for illustration purposes only. Embodiments are not limited to the example applications, modules, or processes.

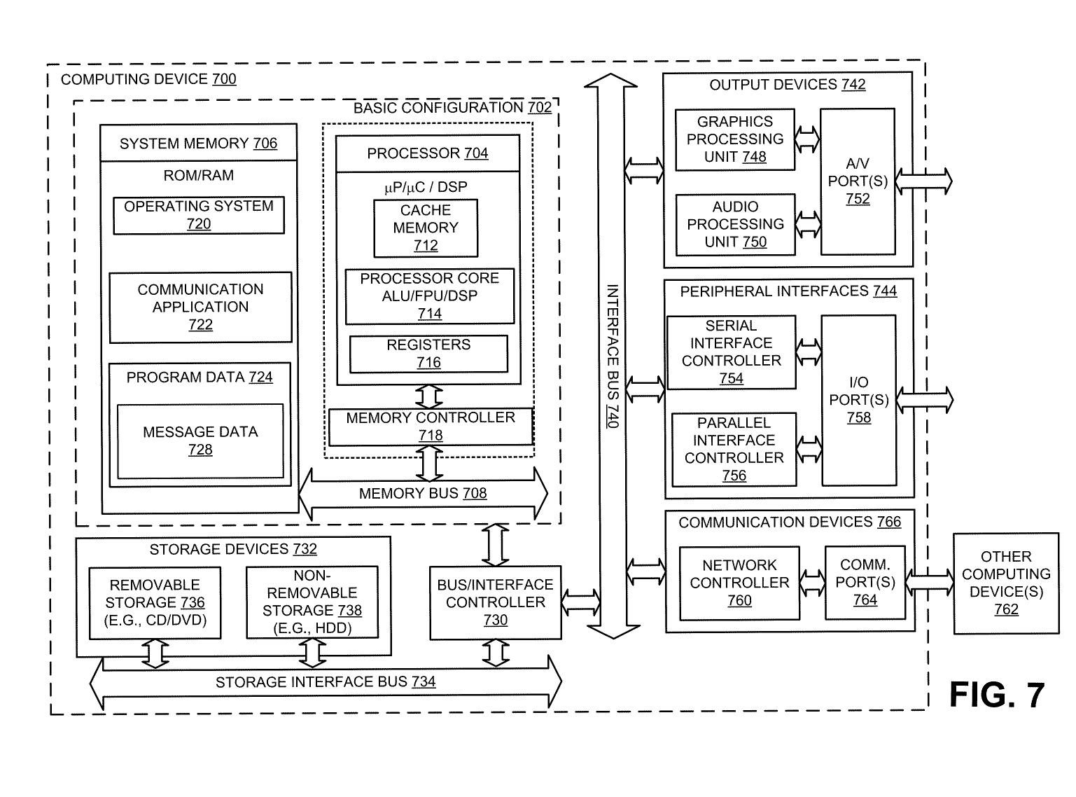

FIG. 7 illustrates a general purpose computing device, which may be configured to optimize a view of messages based on an importance classification, arranged in accordance with at least some embodiments described herein.

For example, the computing device 700 may be used to optimize a view of messages based on an importance classification. In an example of a basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including, but not limited to, a microprocessor (μP), a microcontroller (μC), a digital signal processor (DSP), or any combination thereof. The processor 704 may include one more levels of caching, such as a level cache memory 712, a processor core 714, and registers 716. The processor core 714 may include an arithmetic logic unit (ALU), a floating point unit (FPU), a digital signal processing core (DSP Core), or any combination thereof. A memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a messaging application 722, and a program data 724. The messaging application 722 may detect an action activating an importance filter control to filter summaries of messages based on a classification as an important message. The messages may be processed to identify the important subset of the summaries. The important subset may be displayed while hiding a remaining subset of the summaries on the summary pane. An unread subset of the summaries may be displayed above the subset of the summaries corresponding to the messages classified as important. Components of the messaging application 722 (such as a user interface) may also be displayed on a display device associated with the computing device 700. An example of the display device may include a hardware screen that may be communicatively coupled to the computing device 700. The display device may include a touch based device that detects gestures such as a touch action. The display device may also provide feedback in response to detected gestures (or any other form of input) by transforming a user interface of the messaging application 722, displayed by the touch based device. The program data 724 may also include, among other data, a message data 728, or the like, as described herein. The message data 728 may include a message, and a summary, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736, and the non-removable storage devices 738 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 may include a graphics processing unit 748 and an audio processing unit 750, which may be configured to communicate to various external devices, such as a display or speakers via one or more A/V ports 752. One or more example peripheral interfaces 744 may include a serial interface controller 754 or a parallel interface controller 756, which may be configured to communicate with external devices, such as input devices (for example, keyboard, mouse, pen, voice input device, touch input device, etc.) or other peripheral devices (for example, printer, scanner, etc.) via one or more I/O ports 758. An example communication device 766 may include a network controller 760, which may be arranged to facilitate communications with one or more other computing devices 762 over a network communication link via one or more communication ports 764. The one or more other computing devices 762 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to optimize a view of messages based on an importance classification. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

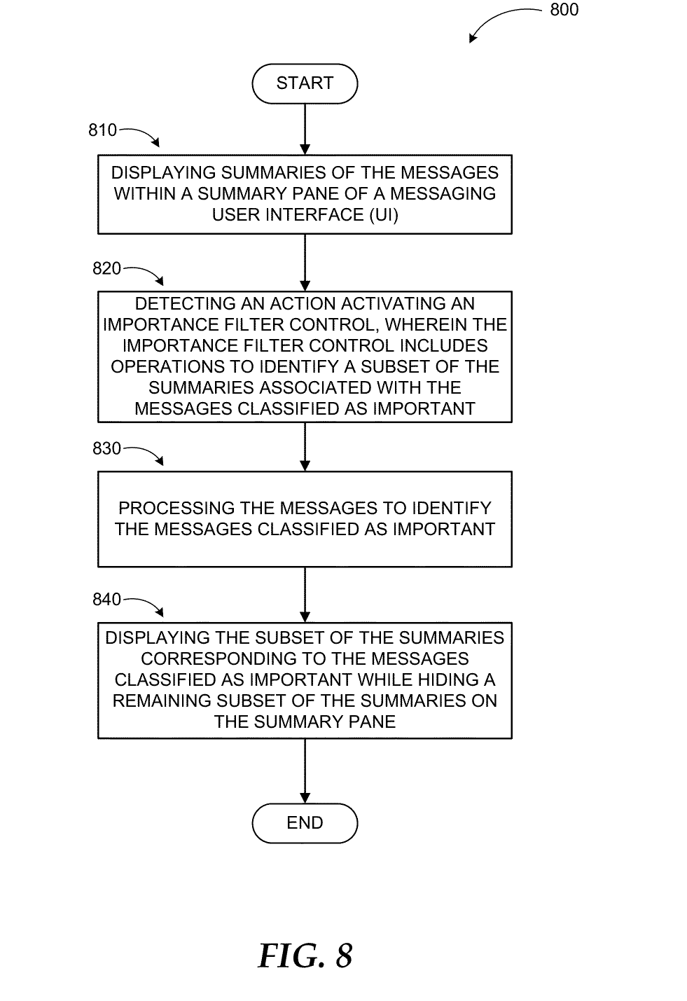

FIG. 8 illustrates a logic flow diagram for a process to optimize a view of messages based on an importance classification, according to embodiments. Process 800 may be implemented on a messaging application.

Process 800 begins with operation 810, where summaries of the messages may be displayed within a summary pane of a messaging user interface (UI). The messages may include emails, text based messages, audio messages, or video messages, among others. At operation 820, an action may be detected that activates an importance filter control, where the importance filter control may include operations to identify an important subset of the summaries associated with the messages classified as an important message. An authorized user may also be enabled to configure the messaging application to display the messages and the summaries with the importance filter control activated by default in response to an activation of the messaging application. The messages may be processed to identify the messages classified as important at operation 830. The subset of the summaries corresponding to the messages classified as important may be displayed, while hiding a remaining subset of the summaries on the summary pane, at operation 840. An unread subset of the summaries may be displayed above the subset of the summaries corresponding to the messages classified as important. The important subset may display importance flag controls that are activated to indicate associated messages that are classified as an important message.

The operations included in process 800 are for illustration purposes. A messaging application according to embodiments may be implemented by similar processes with fewer or additional steps, as well as in different order of operations using the principles described herein.

According to some examples, a method that is executed on a computing device to optimize a view of messages based on an importance classification may be described. The method may include displaying summaries of the messages within a summary pane of a messaging user interface (UI), detecting an action activating an importance filter control, where the importance filter control includes operations to identify a subset of the summaries associated with the messages classified as important, processing the messages to identify the messages classified as important, and displaying the subset of the summaries corresponding to the messages classified as important while hiding a remaining subset of the summaries on the summary pane.

According to other examples, the method may further include displaying one or more of a sender identification, a receiver identification, a message subject that displays a visual indicator of a new message or an unread message, one or more lines summary of a message content, and a timestamp for each of the subset of summaries on the summary pane. An incoming message may be detected and a new summary of the incoming message may be displayed above the subset of the summaries corresponding to the messages classified as important on the summary pane. The subset of the summaries corresponding to the messages classified as important may be sorted based on one or more of: a chronological order, a sender name, and a message subject and a content of one of the messages associated with a recent summary may be displayed on a content pane adjacent to the summary pane. An activation of an importance flag control may be detected on one of the summaries and one of the messages associated with the activated importance flag may be classified as an important message. A deactivation of an importance flag control may be detected on one of the summaries and one of the messages associated with the deactivated summary may be classified as a trivial message.

According to other examples, the method may further include identifying one of the messages as one or more of: an unfinished message, a message from a supervisor, a message sent to self, and a message marked for a follow up action and automatically classifying the identified message as an important message. The method may further include detecting a second action deactivating the importance filter control and displaying the subset of the summaries corresponding to the messages classified as important and the remaining subset of the summaries on the summary pane and detecting a reclassification of one or more of the messages in response to one or more from a set of: a user classification and an automatic classification of the one or more messages as one from a set of: an important message and a trivial message. The method may further include removing a reclassified summary from the subset of the summaries corresponding to the messages classified as important in response to the reclassification of an associated message as the trivial message and in response to detecting a third action activating the importance filter control, displaying the subset of the summaries corresponding to the messages classified as important on the summary pane. The method may further include adding a reclassified summary to the subset of the summaries corresponding to the messages classified as important in response to the reclassification of an associated message as the important message and in response to detecting a third action activating the importance filter control, displaying the subset of the summaries corresponding to the messages classified as important on the summary pane.

According to some examples, a computing device to optimize a view of messages based on an importance classification. The computing device may include a memory, a processor coupled to the memory and the display device. The processor may be configured to execute a messaging application. The messaging application may be configured to display, on the display device, summaries of the messages within a summary pane of a messaging user interface (UI), where the messages include emails, detect an action activating an importance filter control, where the importance filter control includes operations to identify a subset of the summaries associated with the messages classified as important, process the messages to identify the important subset, and display, on the display device, the subset of the summaries corresponding to the messages classified as important while hiding a remaining subset of the summaries on the summary pane.

According to other examples, the messaging application may be further configured to detect a second action deactivating the importance filter control and display, on the display device, the remaining subset of the summaries with the subset of the summaries corresponding to the messages classified as important on the summary pane. The messaging application may be further configured to reduce the remaining subset of summaries to display one or more of: a sender identification, a receiver identification, a message subject that displays a visual indicator of a new message or an unread message, and a timestamp for each of the remaining subset of summaries on the summary pane. The messaging application may be further configured to expand the subset of the summaries corresponding to the messages classified as important to display one or more of: a sender identification, a receiver identification, a message subject that displays a visual indicator of a new message or an unread message, one or more lines summary of a message content, and a timestamp, an icon and a size information for each attached document of an associated message, a thumbnail view for each attached image, video, or document of an associated message for each of the subset of the summaries corresponding to the messages classified as important on the summary pane.

According to further examples, the messaging application may be further configured to expand an unread subset of the summaries to display one or more of: a sender identification, a receiver identification, a message subject that displays a visual indicator of a new message or an unread message, one or more lines summary of a message content, and a timestamp, an icon and a size information for each attached document of an associated message, a thumbnail view for each attached image, video, or document of an associated message for each of the unread subset of summaries, on the summary pane, where the messages associated with the unread subset of summaries are classified as unread messages. The messaging application may be further configured to analyze the messages associated with the subset of the summaries corresponding to the messages classified as important through a machine learning algorithm to classify incoming messages automatically as one from a set of: an important message and a trivial message.

According to some examples, a computer-readable memory device with instructions stored thereon to optimize a view of messages based on an importance classification may be described. The instructions may include actions that are similar to method described above.

According to some examples, a means to optimize a view of messages based on an importance classification may be described. The means to optimize a view of messages based on an importance classification may include a means for displaying summaries of the messages within a summary pane of a messaging user interface (UI), a means for detecting an action activating an importance filter control, where the importance filter control includes operations to identify a subset of the summaries associated with the messages classified as important, a means for processing the messages to identify the messages classified as important, and a means for displaying the subset of the summaries corresponding to the messages classified as important while hiding a remaining subset of the summaries on the summary pane.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to optimize a view of messages based on an importance classification, the method comprising:
displaying summaries of the messages within a summary pane of a messaging user interface (UI);
detecting an action activating an importance filter control, wherein the importance filter control includes operations to identify a subset of the summaries associated with the messages classified as important;
processing the messages to identify the messages classified as important; and
displaying the subset of the summaries corresponding to the messages classified as important while hiding a remaining subset of the summaries on the summary pane.

2. The method of claim 1, further comprising:
displaying one or more of a sender identification, a receiver identification, a message subject that displays a visual indicator of a new message or an unread message, one or more lines summary of a message content, and a timestamp for each of the subset of summaries on the summary pane.

3. The method of claim 1, further comprising:
detecting an incoming message; and
displaying a new summary of the incoming message above the subset of the summaries corresponding to the messages classified as important on the summary pane.

4. The method of claim 1, further comprising:
sorting the subset of the summaries corresponding to the messages classified as important based on one or more of: a chronological order, a sender name, and a message subject; and
displaying a content of one of the messages associated with a recent summary on a content pane adjacent to the summary pane.

5. The method of claim 1, further comprising:
detecting an activation of an importance flag control on one of the summaries; and
classifying one of the messages associated with the activated importance flag as an important message.

6. The method of claim 1, further comprising:
detecting a deactivation of an importance flag control on one of the summaries; and
classifying one of the messages associated with the deactivated summary as a trivial message.

7. The method of claim 1, further comprising:
identifying one of the messages as one or more of: an unfinished message, a message from a supervisor, a message sent to self, and a message marked for a follow up action; and
automatically classifying the identified message as an important message.

8. The method of claim 1, further comprising:
detecting a second action deactivating the importance filter control; and
displaying the subset of the summaries corresponding to the messages classified as important and the remaining subset of the summaries on the summary pane.

9. The method of claim 8, further comprising:
detecting a reclassification of one or more of the messages in response to one or more from a set of: a user classification and an automatic classification of the one or more messages as one from a set of: an important message and a trivial message.

10. The method of claim 9, further comprising:
removing a reclassified summary from the subset of the summaries corresponding to the messages classified as important in response to the reclassification of an associated message as the trivial message; and
in response to detecting a third action activating the importance filter control, displaying the subset of the summaries corresponding to the messages classified as important on the summary pane.

11. The method of claim 9, further comprising:
adding a reclassified summary to the subset of the summaries corresponding to the messages classified as important in response to the reclassification of an associated message as the important message; and
in response to detecting a third action activating the importance filter control, displaying the subset of the summaries corresponding to the messages classified as important on the summary pane.

12. A computing device to optimize a view of messages based on an importance classification, the computing device comprising:
a display device;
a memory;
a processor coupled to the memory and the display device, the processor executing a messaging application in conjunction with instructions stored in the memory, wherein the messaging application is configured to:
display, on the display device, summaries of the messages within a summary pane of a messaging user interface (UI), wherein the messages include emails;
detect an action activating an importance filter control, wherein the importance filter control includes operations to identify a subset of the summaries associated with the messages classified as important;
process the messages to identify the important subset; and
display, on the display device, the subset of the summaries corresponding to the messages classified as important while hiding a remaining subset of the summaries on the summary pane.

13. The computing device of claim 12, wherein the messaging application is further configured to:
detect a second action deactivating the importance filter control; and
display, on the display device, the remaining subset of the summaries with the subset of the summaries corresponding to the messages classified as important on the summary pane.

14. The computing device of claim 13, wherein the messaging application is further configured to:
reduce the remaining subset of summaries to display one or more of: a sender identification, a receiver identification, a message subject that displays a visual indicator of a new message or an unread message, and a timestamp for each of the remaining subset of summaries on the summary pane.

15. The computing device of claim 13, wherein the messaging application is further configured to:
expand the subset of the summaries corresponding to the messages classified as important to display one or more of: a sender identification, a receiver identification, a message subject that displays a visual indicator of a new message or an unread message, one or more lines summary of a message content, and a timestamp, an icon and a size information for each attached document of an associated message, a thumbnail view for each attached image, video, or document of an associated message for each of the subset of the summaries corresponding to the messages classified as important on the summary pane.

16. The computing device of claim 13, wherein the messaging application is further configured to:
expand an unread subset of the summaries to display one or more of: a sender identification, a receiver identification, a message subject that displays a visual indicator of a new message or an unread message, one or more lines summary of a message content, and a timestamp, an icon and a size information for each attached document of an associated message, a thumbnail view for each attached image, video, or document of an associated message for each of the unread subset of summaries, on the summary pane, wherein the messages associated with the unread subset of summaries are classified as unread messages.

17. The computing device of claim 12, wherein the messaging application is further configured to:
analyze the messages associated with the subset of the summaries corresponding to the messages classified as important through a machine learning algorithm to classify incoming messages automatically as one from a set of: an important message and a trivial message.

18. A computer-readable memory device with instructions stored thereon to optimize a view of messages based on an importance classification, the instructions comprising:
displaying summaries of the messages within a summary pane of a messaging user interface (UI), display device, wherein the messages include one or more of emails, text based messages, audio messages, and video messages;
detecting an action activating an importance filter control, wherein the importance filter control include operations to identify a subset of the summaries corresponding to the messages classified as important;
processing the messages to identify the subset of the summaries corresponding to the messages classified as important; and
displaying the subset of the summaries corresponding to the messages classified as important while displaying an unread subset of the summaries above the subset of the summaries corresponding to the messages classified as important and hiding a remaining subset of the summaries on the summary pane.

19. The computer-readable memory device of claim 18, wherein the instructions further comprise:
detecting a reclassification of one or more of the messages in response to one or more from a set of: a user classification and an automatic classification of the one or more messages as one from a set of: an important message and a trivial message;
removing a reclassified summary from the subset of the summaries corresponding to the messages classified as important in response to the reclassification of an associated message as the trivial message; and
adding a reclassified summary to the subset of the summaries corresponding to the messages classified as important in response to the reclassification of an associated message as the important message.

20. The computer-readable memory device of claim 18, wherein the instructions further comprise:
detecting a second action deactivating the importance filter control;
displaying the remaining subset with the subset of the summaries corresponding to the messages classified as important on the summary pane; and
reducing unread summaries from the remaining subset to display one or more of: a sender identification, a receiver identification, a message subject, and a timestamp for each of the unread summaries on the summary pane, wherein the messages associated with the unread summaries are classified as unread messages.
